(19) United States
(12) Patent Application Publication
(10) Pub. No.: US 2020/0157476 A1
(43) Pub. Date: May 21, 2020

(54) COMPOSITION AND METHOD FOR REMOVING STAINS FROM FABRICS

(71) Applicant: The Procter & Gamble Company, Cincinnati, OH (US)

(72) Inventors: Rachel Marie APPLEGATE, Loveland, OH (US); Sarah Ann DELANEY, Hebron, KY (US)

(21) Appl. No.: 16/683,399

(22) Filed: Nov. 14, 2019

Related U.S. Application Data
(60) Provisional application No. 62/768,400, filed on Nov. 16, 2018.

(51) Int. Cl. C11D 11/00; C11D 3/20; C11D 3/33

(52) U.S. Cl. CPC C11D 11/0017; C11D 3/2079; C11D 3/2089; C11D 3/33; C11D 3/2086; C11D 3/2082

(57) ABSTRACT

A composition for removing stains by the interaction of perspiration with aluminum compounds from fabrics having between 10% and 25% of an organic acid. Methods of making and using the same.

### FIELD OF THE INVENTION

The present disclosure relates to stain removing compositions and, more specifically, to compositions and a method for removing stains from clothing caused by the interaction of human perspiration with commercial antiperspirants containing aluminum compounds.

### BACKGROUND OF THE INVENTION

The problem of the armpit stains exists because many commercial antiperspirants utilize aluminum chlorohydrate and aluminum zirconium to block pores and inhibit sweat. When mixed with perspiration and other body soils, these aluminum compounds are known to oxidize which produces a stain on the clothing having a tint. Well known stain removers and fabric whiteners, such as bleach, are not effective in removing the tint and can cause the stain to become permanently set in the fabric.

Additionally, consumers are becoming busier with more expectations on their time. For example, in the United States, over 60% of two parent households with children have both parents working. As such, consumers require convenience. This represents being able to set it and forget it. Additionally, the use of products must be convenient and seamless to the user. Unfortunately, many of the traditional armpit stain treatments can cause irreversible damage to the fabric if left on the fabric for an extended period of time. This is particularly true because many shirts comprise solid colors and/or color patterns. Said otherwise, as work environments have moved to more casual dress, there has been an increase in use of dress shirts with color patterns and a decrease in use in the traditional white dress shirt.

Traditionally, stain treatments are kept and used in laundry rooms or with other detergent products. As such, there remains a need to create an armpit stain removal product that can be used at the point of undressing (such as in a bedroom or bathroom) thereby allowing one to treat the fabric at the point of undressing and forgetting about it without causing irreversible damage to the fabric. Effectively, allowing one to place the treated fabric in a hamper until it is convenient to the user to wash the bundle of used clothing.

### SUMMARY OF THE INVENTION

A composition for removing stains by the interaction of perspiration with aluminum compounds from fabrics is disclosed. The composition includes between 10% and 25% of an organic acid; a surfactant; a polymer; and water.

A composition for removing stains by the interaction of perspiration with aluminum compounds from fabrics is further disclosed. The composition includes between 10% and 25% of an organic acid selected from the group consisting of from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof; a surfactant; a polymer; an alkalizing agent; and water.

A method of treating a stain caused by the interaction of perspiration with aluminum compounds is disclosed. The method includes providing a phosphate free and free of phosphoric acid composition. The phosphate free and free of phosphoric acid composition includes between 10% and 25% of an organic acid, a surfactant, a polymer, an alkalizing agent, and water. The method further includes applying the composition directly on the one or more stains on the fabric; allowing the composition to interact with one or more aluminum compounds in the stained areas of the fabric for at least 5 minutes; and laundering the fabric in water mixed with a laundry detergent.

### DETAILED DESCRIPTION OF THE INVENTION

In this description, all concentrations and ratios are on a weight basis of the stain removing composition unless otherwise specified. Elemental compositions such as percentage nitrogen (% N) are percentages by weight.

Molecular weights of polymers are number average molecular weights unless otherwise specifically indicated.

As used herein, the articles “a” and “an” when used in a claim, are understood to mean one or more of what is claimed or described.

As used herein, the terms “include,” “includes,” and “including” are meant to be non-limiting.

The term “renewable” is synonomous with the terms “biobased,” “sustainable,” “sustainably derived,” or “from sustainable sources” and means bio-derived (derived from a renewable resource, e.g., plants) or “non-geologically derived.” “Geologically derived” means derived from, for example, petrochemicals, natural gas, or coal. “Geologically derived” materials cannot be easily replenished or regrown (e.g., in contrast to plant- or algae-produced oils).

As used herein, the term “renewable component” refers to a component that is derived from renewable feedstock and contains renewable carbon. A renewable feedstock is a feedstock that is derived from a renewable resource, e.g., plants, and non-geologically derived. A material may be partially renewable (less than 100% renewable carbon content, from about 1% to about 50% renewable carbon content) or 100% renewable (100% renewable carbon content). A renewable material may be blended with a nonrenewable material.

“Renewable carbon” may be assessed according to the “Assessment of the Biobased Content of Materials” method, ASTM D6866.

As used herein, the term “natural oils” means oils that are derived from plant or algae matter (also referred to as renewable oils). Natural oils are not based on kerosene or other fossil fuels. The term “oils” include fats, fatty acids, waste fats, oils, or mixtures thereof. Natural oils include, but are not limited to, coconut oil, babassu oil, castor oil, algae byproduct, beef tallow oil, borage oil, camelina oil, Canola® oil, choice white grease, coffee oil, corn oil, Cuphea Viscosissima oil, evening primrose oil, fish oil, hemp oil, hepar oil, jatropha oil, Lesquerella Fendleri oil, linseed oil, Moringa Oleifera oil, mustard oil, neem oil, palm oil, perilla seed oil, poultry fat, rice bran oil, soybean oil, stillingia oil, sunflower oil, tung oil, yellow grease, cooking oil, and other vegetable, nut, or seed oils. A natural oil typically includes triglycerides, free fatty acids, or a combination of triglycerides and free fatty acids, and other trace compounds.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

The compositions of the present invention can comprise, consist essentially of, or consist of, the components of the present disclosure.

Unless otherwise noted, all component or composition levels are in reference to the active portion of that component or composition, and are exclusive of impurities, for example, residual solvents or by-products, which may be present in commercially available sources of such components or compositions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Stain Removing Composition

As used herein the phrase “stain removing composition” includes compositions and formulations designed for cleaning soiled material. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation. The cleaning compositions may have a form selected from liquid, single-phase or multi-phase unit dose, pouch, gel, or paste. When the compositions are in a unit dose form, the composition may be encapsulated in a water-soluble film or pouch; the water-soluble film or pouch may comprise polyvinyl alcohol, polyvinyl acetate, or mixtures thereof. The unit dose form may comprise at least two compartments, or at least three compartments. At least one compartment may be superimposed on another compartment.

In some aspects, the compositions comprise from about 50% to about 95%, or from about 60% to about 90%, or from about 65% to about 81%, by weight of the composition, water. In some aspects, the compositions comprise at least about 50%, or at least about 60%, or at least about 70%, or at least about 75%, or at least about 80%, or at least about 85% water. When the composition is in concentrated or unit dose form, the composition may comprise less than about 50% water, or less than about 30% water, or less than about 20% water, or less than about 10% water, or less than about 5% water.

The stain removing compositions disclosed herein may contain from 0%, or from about 1%, or from about 5%, or from about 10%, or from about 20% or from about 30%, of from about 40% or from about 50%, to about 40%, or to about 50%, or to about 60% or to about 70% or to about 80% or to about 90%, or to about 100% by weight of renewable components.

The compositions may have at least 50% transmittance of light using a 1 centimeter cuvette, at a wavelength of 410-800 nanometers, or 570-690 nanometers, where the composition is substantially free of dyes. The composition may have greater than 50% transmittance, at least 70% transmittance, or at least 80% transmittance of light using a 1 centimeter curvette, at a wavelength of 410-800 nanometers, or 570-690 nanometers, where the composition is substantially free of dyes.

Alternatively, transparency of the composition may be measured as having an absorbency in the visible light wavelength (about 410 to 800 nm) of less than 0.3, which is in turn equivalent to at least 50% transmittance using cuvette and wavelength noted above. For purposes of the disclosure, as long as one wavelength in the visible light range has greater than 50% transmittance, it is considered to be transparent/translucent.

In some aspects, the compositions are present in a single phase. In some aspects, the disclosed compositions are isotropic at 22° C. As used herein, “isotropic” means a clear mixture, having a % transmittance of greater than 50% at a wavelength of 570 nm measured via a standard 10 mm pathlength cuvette with a Beckman DU spectrophotometer, in the absence of dyes and/or opacifiers.

The laundry stain removing composition(s) may comprise surfactants derived from renewable fatty alcohol. The composition may be substantially free of dye and brightener. The laundry stain removing composition(s) may be a liquid.

### Surfactant

The products of the present invention may comprise from about 0.00 wt %, more typically from about 0.10 to 80% by weight of a surfactant. In one aspect, such compositions may comprise from about 5% to 50% by weight of surfactant. Surfactants utilized can be of the anionic, nonionic, amphoteric, ampholytic, zwitterionic, or cationic type or can comprise compatible mixtures of these types. Anionic and nonionic surfactants are typically employed if the fabric care product is a laundry detergent. On the other hand, cationic surfactants are typically employed if the fabric care product is a fabric softener.

### Nonionic Surfactant

Preferably the composition comprises a nonionic detersive surfactant. Suitable nonionic surfactants include alkoxylated fatty alcohols. The nonionic surfactant may be selected from ethoxylated alcohols and ethoxylated alkyl phenols of the formula R(OC2H4), OH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. Other non-limiting examples of nonionic surfactants useful herein include: C8-C18 alkyl ethoxylates, such as, NEODOL® nonionic surfactants from Shell; C6-C12 alkyl phenol alkoxylates where the alkoxylate units may be ethyleneoxy units, propyleneoxy units, or a mixture thereof; C12-C18 alcohol and C6-C12 alkyl phenol condensates with ethylene oxide/propylene oxide block polymers such as Pluronic® from BASF; C14-C22 mid-chain branched alcohols, BA; C14-C22 mid-chain branched alkyl alkoxylates, BAEX, wherein x is from 1 to 30; alkylpolysaccharides; specifically alkylpolyglycosides; polyhydroxy fatty acid amides; and ether capped poly(oxyalkylated) alcohol surfactants. Specific example include C12-C15 EO7 and C14-C15 EO7 NEODOL® nonionic surfactants from Shell, C12-C14 EO7 and C12-C14 EO9 Surfonic® nonionic surfactants from Huntsman.

Highly preferred nonionic surfactants are the condensation products of Guerbet alcohols with from 2 to 18 moles, preferably 2 to 15, more preferably 5-9 of ethylene oxide per mole of alcohol or 7-9 of ethylene oxide per mole of alcohol. Suitable nonionic surfactants include those with the trade name Lutensol® from BASF. Lutensol XP-50 is a Guerbet ethoxylate that contains 5 ethoxy groups. Lutensol XP-80 and containing 8 ethoxy groups. Other suitable non-ionic surfactants for use herein include fatty alcohol polyglycol ethers, alkylpolyglucosides and fatty acid glucamides, alkylpolyglucosides based on Guerbet alcohols.

Anionic Surfactant

Useful anionic surfactants can themselves be of several different types. For example, water-soluble salts of the higher fatty acids, i.e., “soaps”, are useful anionic surfactants in the compositions herein. This includes alkali metal soaps such as the sodium, potassium, ammonium, and alkylolammonium salts of higher fatty acids containing from about 8 to about 24 carbon atoms, or even from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap.

Preferred alkyl sulphates are C8-18 alkyl alkoxylated sulphates, preferably a C12-15 alkyl or hydroxyalkyl alkoxylated sulphates. Preferably the alkoxylating group is an ethoxylating group. Typically the alkyl alkoxylated sulphate has an average degree of alkoxylation from 0.5 to 30 or 20, or from 0.5 to 10. The alkyl group may be branched or linear. The alkoxylated alkyl sulfate surfactant may be a mixture of alkoxylated alkyl sulfates, the mixture having an average (arithmetic mean) carbon chain length within the range of about 12 to about 30 carbon atoms, or an average carbon chain length of about 12 to about 15 carbon atoms, and an average (arithmetic mean) degree of alkoxylation of from about 1 mol to about 4 mols of ethylene oxide, propylene oxide, or mixtures thereof, or an average (arithmetic mean) degree of alkoxylation of about 1.8 mols of ethylene oxide, propylene oxide, or mixtures thereof. The alkoxylated alkyl sulfate surfactant may have a carbon chain length from about 10 carbon atoms to about 18 carbon atoms, and a degree of alkoxylation of from about 0.1 to about 6 mols of ethylene oxide, propylene oxide, or mixtures thereof. The alkoxylated alkyl sulfate may be alkoxylated with ethylene oxide, propylene oxide, or mixtures thereof Alkyl ether sulfate surfactants may contain a peaked ethoxylate distribution. Specific example include C12-C15 EO 2.5 Sulfate, C14-C15 EO 2.5 Sulfate and C12-C15 EO 1.5 Sulfate derived from NEODOL® alcohols from Shell and C12-C14 EO3 Sulfate, C12-C16 EO3 Sulfate, C12-C14 EO2 Sulfate and C12-C14 EO1 Sulfate derived from natural alcohols from Huntsman.

The AES may be linear, branched, or combinations thereof. The alkyl group may be derived from synthetic or natural alcohols such as those supplied by the tradename Neodol® by Shell, Safol®, Lial®, and Isalchem® by Sasol or midcut alcohols derived from vegetable oils such as coconut and palm kernel.

Other useful anionic surfactants can include the alkali metal salts of alkyl benzene sulfonates, in which the alkyl group contains from about 9 to about 15 carbon atoms, in straight chain (linear) or branched chain configuration. In some examples, the alkyl group is linear. Such linear alkylbenzene sulfonates are known as “LAS.” In other examples, the linear alkylbenzene sulfonate may have an average number of carbon atoms in the alkyl group of from about 11 to 14. In a specific example, the linear straight chain alkylbenzene sulfonates may have an average number of carbon atoms in the alkyl group of about 11.8 carbon atoms, which may be abbreviated as C11.8 LAS. Preferred sulphonates are C10-13 alkyl benzene sulphonate. Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the trade name Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used. Suitable anionic sulfonate surfactants for use herein include water-soluble salts of C8-C18 alkyl or hydroxyalkyl sulfonates; C11-C18 alkyl benzene sulfonates (LAS), modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulfonate (MES); and alpha-olefin sulfonate (AOS). Those also include the paraffin sulfonates may be monosulfonates and/or disulfonates, obtained by sulfonating paraffins of 10 to 20 carbon atoms. The sulfonate surfactant may also include the alkyl glyceryl sulfonate surfactants.

Anionic surfactants of the present invention may exist in an acid form, and said acid form may be neutralized to form a surfactant salt which is desirable for use in the present stain removing compositions. Typical agents for neutralization include the metal counterion base such as hydroxides, e.g., NaOH or KOH. Further preferred agents for neutralizing anionic surfactants of the present invention and adjunct anionic surfactants or co-surfactants in their acid forms include ammonia, amines, or alkanolamines. Alkanolamines are preferred. Suitable non-limiting examples including monoethanolamine, diethanolamine, triethanolamine, and other linear or branched alkanolamines known in the art; for example, highly preferred alkanolamines include 2-amino- 1 -propanol, 1-aminopropanol, monoisopropanolamine, or 1-amino-3-propanol.

### Stain Removing Composition Amphoteric Surfactant

The surfactant system may include amphoteric surfactant, such as amine oxide. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety.

### Ampholytic Surfactants

The surfactant system may comprise an ampholytic surfactant. Specific, non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents may contain at least about 8 carbon atoms, for example from about 8 to about 18 carbon atoms, and at least one contains an anionic water-solubilizing group, e.g. carboxy, sulfonate, sulfate. See U.S. Pat. No. 3,929,678 at column 19, lines 18-35, for suitable examples of ampholytic surfactants.

Zwitterionic surfactant

Zwitterionic surfactants are known in the art, and generally include surfactants which are neutrally charged overall, but carry at least one positive charged atom/group and at least one negatively charged atom/group. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds.

See U.S. Pat. No. 3,929,678 at column 19, line 38 through column 22, line 48, for examples of zwitterionic surfactants; betaines, including alkyl dimethyl betaine and cocodimethyl amidopropyl betaine, C8 to C18 (for example from C12 to C18) amine oxides and sulfo and hydroxy betaines, such as N-alkyl-N,N-dimethylammino- 1 -propane sulfonate where the alkyl group can be C8 to C18 and in certain embodiments from C10 to C14. A preferred zwitterionic surfactant for use in the present invention is the cocoamidopropyl betaine.

Cationic surfactants

Examples of cationic surfactants include quaternary ammonium surfactants, which can have up to 26 carbon atoms specific. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002, WO 98/35003, WO 98/35004, WO 98/35005, and WO 98/35006, which is herein incorporated by reference; d) cationic ester surfactants as discussed in U.S. Pat. Nos. 4,228,042, 4,239,660 4,260,529 and 6,022,844, which is herein incorporated by reference; and e) amino surfactants as discussed in U.S. Pat. No. 6,221,825 and WO 00/47708, which is herein incorporated by reference, and specifically amido propyldimethyl amine (APA). Useful cationic surfactants also include those described in U.S. Pat. No. 4,222,905, Cockrell, issued Sep. 16, 1980, and in U.S. Pat. No. 4,239,659, Murphy, issued Dec. 16, 1980, both of which are also incorporated herein by reference. Quaternary ammonium compounds may be present in fabric enhancer compositions, such as fabric softeners, and comprise quaternary ammonium cations that are positively charged polyatomic ions of the structure NR4+, where R is an alkyl group or an aryl group.

### Chelants

Preferably the composition comprises up to 5% of a chelating agents and/or crystal growth inhibitor. Suitable molecules include copper, iron and/or manganese chelating agents and mixtures thereof. Suitable molecules include aminocarboxylates, aminophosphonates, succinates, salts thereof, and mixtures thereof. Non-limiting examples of suitable chelants for use herein include ethylenediaminetetracetates, N-(hydroxyethyl)-ethylene-diamine-triacetates, nitrilotriacetates, ethylenediamine tetraproprionates, triethylene-tetraamine-hexacetates, diethylenetriamine-pentaacetates, ethanoldiglycines, ethylenediaminetetrakis (methylenephosphonates), diethylenetriamine penta(methylene phosphonic acid) (DTPMP), ethylenediamine disuccinate (EDDS), hydroxyethanedimethylenephosphonic acid (HEDP), methylglycinediacetic acid (MGDA), diethylenetriaminepentaacetic acid (DTPA), and 1,2-diydroxybenzene-3,5-disulfonic acid (Tiron), salts thereof, and mixtures thereof. Tiron as well as other sulphonated catechols may also be used as effective heavy metal chelants. Other non-limiting examples of chelants of use in the present invention are found in U.S. Pat. Nos. 7,445,644, 7,585,376 and 2009/0176684A1. Other suitable chelating agents for use herein are the commercial DEQUEST series, and chelants from Monsanto, DuPont, and Nalco Inc.

Optical brighteners or other brightening or whitening agents may be incorporated at levels of from about 0.01% to about 3%, by weight of the composition, into the cleaning compositions described herein. Commercial optical brighteners, which may be used herein, can be classified into subgroups, which include, but are not necessarily limited to, derivatives of stilbene, pyrazoline, coumarin, carboxylic acid, methinecyanines, dibenzothiphene-5,5-dioxide, azoles, 5 and 6-membered-ring heterocycles, and other miscellaneous agents. Examples of such brighteners are disclosed in “The Production and Application of Fluorescent Brightening Agents,” M. Zahradnik, John Wiley & Sons, New York (1982). Specific, non-limiting examples of optical brighteners which may be useful in the present compositions are those identified in U.S. Pat. Nos. 4,790,856 and 3,646,015. Preferred Brighteners include Disodium 4,4′-bis{[4-anilino-6-[bis(2-hydroxyethyl)amino-s-triazin-2-yl]-amino}-2,2′-stilbenedisulfonate, 4,4′-bis{[4-anilino-6-morpholino-s-triazin-2-yl]-amino}-2,2′-stilbenedisulfonate, Disodium 4,4″-bis[(4,6-di-anilino-s-triazin-2-yl)-amino]-2,2′-stilbenedisulfonate and disodium 4,4′-bis-(2-sulfostyryl)biphenyl.

### Aesthetic Colorants

The composition may comprise an aesthetic colorant or dye. Aesthetic colorants include Liquitint® Blue AH, Liquitint® Blue BB, Liquitint® Blue 275, Liquitint® Blue 297, Liquitint® Blue BB, Cyan 15, Liquitint® Green 101, Liquitint® Orange 272, Liquitint® Orange 255, Liquitint® Pink AM, Liquitint® Pink AMC, Liquitint® Pink ST, Liquitint® Violet 129, Liquitint® Violet LS, Liquitint® Violet 291, Liquitint® Yellow FT, Liquitint® Blue Buf, Liquitint® Pink AM, Liquitint® Pink PV, Acid Blue 80, Acid Blue 182, Acid Red 33, Acid Red 52, Acid Violet 48, Acid Violet 126, Acid Blue 9, Acid Blue 1, and mixtures thereof.

Organic acid

The stain removing composition comprises one or more organic acids selected from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof. Preferably, the stain removing composition may comprise an organic acid selected from the group consisting of acetic acid, lactic acid, and citric acid.

The stain removing compositions of the present invention may comprise one or more additional organic acids. The additional organic acid may be in the form of an organic carboxylic acid or polycarboxylic acid. Examples of organic acids that may be used include: acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof. In some aspects, the composition comprises organic acids that can also serve as detergent builders, such as citric acid.

The organic acid may be a water-soluble or water-miscible acid. In some aspects, the organic acid has a solubility in water at 20° C. of at least about 10 g acid/100 ml water, or at least about 30 g acid/100 ml water, or at least about 50 g acid/100 ml water, or at least about 70 g acid/100 ml water, or at least about 85 g/100 ml water. In some aspects, the composition is substantially free of fatty acid.

The organic acid may be a low-weight acid, for example, an acid having a molecular weight of less than 210 g/mole. In some aspects, the organic acid has no more than nine carbon atoms, alternatively no more than six carbon atoms. The organic acid in the stain removing composition may have no more than four carbon atoms, or no more than three carbon atoms, or fewer than three carbon atoms. Specific examples of organic acids having fewer than three carbon atoms include formic acid and acetic acid.

The compositions may comprise from about 6% to about 30%, or from about 8% to about 25%, or from about 10% to about 15%, or from about 12% to about 17%, by weight of the composition, of the organic acid, such as, for example, 13%, 14%, 15%, 16%, 17%, 18%, 19%, 20%, 21%, 22%, 23%, 24%. The compositions may comprise greater than 10% by weight of the composition, of the organic acid, such as, for example, greater than 15%, greater than 20%, or greater than 25%. The composition may comprise a ratio of surfactant system to organic acid of less than or equal to about 3, such as, for example, between 0.1 and 3, such as, for example, 0.5, 1, 1.5,2 or 2.5.

The compositions may comprise a preservative. Suitable preservatives may be selected by one of ordinary skill in the art and may include Proxel™ (available from Arch Chemicals/Lonza).

The composition may comprise from about 0.01% to about 2.0%, or about 0.1% to about 1.0%, or about 0.1% to about 0.3%, by weight of the composition, of preservative. In some aspects, the compositions comprise less than 0.01% of a preservative. In some aspects, the compositions are substantially free of preservatives or, preferably, preservative free.

In some aspects, an alkalizing agent is added to the composition in order to obtain the desirable neat pH of the composition. Suitable alkalizing agents include hydroxides of alkali metals or alkali earth metals, such as sodium hydroxide, or alkanolamines, such as methanolamine (MEA) or triethanolamine (TEA) or mixtures thereof. In some aspects, the composition from about 0.25%, or from about 0.3%, or from about 0.3 5%, or from about 0.4% to about 10%, or to about 5% or to about 2%, or to about 1%, by weight of the composition, of an alkalizing agent, preferably sodium hydroxide. An alkalizing agent that provides buffering capacity to the composition may be particularly useful in helping to stabilize the sulfated surfactant.

The stain removing compositions described herein may comprise from about 1% to about 20%, or from about 1% to about 12%, or from about 1% to about 10% by weight the composition, of one or more solvents. Liquid stain removing compositions and other forms of stain removing compositions that include a liquid component (such as liquid-containing unit dose stain removing compositions) may contain one or more solvents and water.

Suitable solvents include lipophilic fluids, including siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, and mixtures thereof. Low molecular weight primary or secondary alcohols exemplified by methanol, ethanol, propanol, and isopropanol are also suitable. Monohydric alcohols may be used in some examples for solubilizing surfactants, and polyols such as those containing from 2 to about 6 carbon atoms and from 2 to about 6 hydroxy groups (e.g., ethylene glycol, glycerine, and 1,2-propanediol) may also be used.

Suitable solvents include ethanol, diethylene glycol (DEG), 2-methyl-1,3-propanediol (MPD), dipropylene glycol (DPG), oligamines (e.g., diethylenetriamine (DETA), tetraethylenepentamine (TEPA)), glycerine, propoxylated glycerine, ethoxylated glycerine, ethanol, 1,2-propanediol (also referred to as propylene glycol), diethylene glycol, dipropylene glycol, 1,3-propanediol, 2,3-butanediol, cellulosic ethanol, renewable propylene glycol, renewable dipropylene glycol, renewable 1,3-propanediol, other solvents used in detergent formulations, and mixtures thereof.

The stain removing compositions described herein may comprise from about 1% to about 20% by weight of a solvent comprising 1,2-propanediol, renewable 1,2-propanediol, 1,3-propanediol, renewable 1,3-propanediol, ethanol, cellulosic ethanol, or mixtures thereof. The stain removing compositions described herein may comprise from about 1% to about 18% by weight of a solvent comprising 1,2-propanediol, renewable 1,2-propanediol, ethanol, cellulosic ethanol, or mixtures thereof. The stain removing compositions described herein may comprise from about 2% to about 16% by weight, such as, for example, 3%, 4%, 5%, 6%, 7%, 8%, 9%, 10%, 11%, 12%, 13%, 14%, or 15% of a solvent comprising 1,2-propanediol, renewable 1,2-propanediol, ethanol, cellulosic ethanol, or mixtures thereof.

Biobased propylene glycol is described in U.S. Pat. No. 7,928,148 and available from ADM. Biobased 1,3-propanediol is described in U.S. Pat. No. 8,436,046 and available from DuPont Tate & Lyle Bio Products Company, LLC.

Biobased propylene glycol may be made by catalytic hydrogenolysis (hydro cracking) of polyol. Catalytic hydrogenolysis is a process whereby polyols such as sugars, glycerol, and/or glycols are reacted with hydrogen to produce other polyols. The polyols so produced often comprise a mixture of several polyols having a lower average molecular weight than the starting material. The conversion of polyols, such as sugars and glycerol, to polyhydric alcohols, such as propylene glycol and ethylene glycol, by hydrogenolysis or by hydrocracking results in the formation of not only these alcohols, but several other products, such as 1,2-butanediol, 1,3-butanediol, 1,4-butanediol, 2,3-butanediol and 2,4-pentanediol. These products are recovered as impurities with the propylene glycol and ethylene glycol. For example, in hydrocracking of higher carbohydrates, such as sorbitol, to produce propylene glycol, typically 3-5% by weight of 2,3-butanediol is produced in addition to 1,2-butanediol, ethylene glycol, and 1,3-butanediol. U.S. Pat. No. 7,928,148 (citing U.S. Pat. No. 4,935,102) discloses a list of polyols that are produced by hydrocracking of sorbitol (Table 2):

TABLE 2
Polyols produced by Hydrocracking of
Sorbitol (U.S. Pat. No. 4,935,102)

| | Weight | Boiling Point, |
|---|---|---|
| Compound | Percent | ° C. |
| 2,3-Butanediol | 3.5 | 182 |
| Propylene glycol | 16.5 | 187 |
| 1,2-Butanediol | 2.0 | 192 |
| Ethylene glycol | 25.2 | 198 |
| 1,3-Butanediol | 2.7 | 206 |
| 2,3-Hexanediol | | 206 |
| 1,2-Pentanediol | | 210 |
| 1,4-Pentanediol | | 220 |
| 1,4-Butanediol | 2.1 | 230 |
| 1,5-Pentanediol | 0.1 | 242 |
| Diethylene glycol | 2.2 | 245 |
| 1,6-Hexanediol | | 250 |
| Triethylene glycol | 2.1 | 285 |

The stain removing composition described herein may comprise from about 0.01% to about 0.1% of polyhydric alcohol. The stain removing compositions described herein may comprise a polyhydric alcohol selected from the group consisting of 2,3-butanediol, 2,3-pentanediol, 2,4-pentanediol, 1,2-butanediol, 2,3-hexandiol, 1,5-pentanediol, and mixtures thereof, The stain removing compositions described herein may comprise from about 0.01% to about 0.1% of 2,3-hexandiol.

In some aspects, the composition comprises water and is substantially free of organic solvent. In other aspects, the composition may comprise organic solvent. Preferred organic solvents include 1,2-propanediol, methanol, ethanol, glycerol, dipropylene glycol, diethylene glycol (DEG), methyl propane diol, and mixtures thereof. Other lower alcohols, such C1-C4 alkanolamines, e.g. monoethanolamine and/or triethanolamine, can also be used.

In some aspects, the compositions comprise from about 0.05% to about 25%, or from about 0.1% to about 15%, or from about 1% to about 10%, or from about 2% to about 5%, by weight of the composition, organic solvent. In some aspects, the composition comprises less than 5% or less than 1% of organic solvent.

The compositions of the present disclosure are acidic and have a pH less than about 7, when measured in a neat solution of the composition at 20±2° C. In some aspects, the pH of the composition is from about 2 to about 6.9, or from about 2 to about 6, or from about 2 to about 5, or from about 2.1 to about 4, or from about 2 to about 3, or from about 2.4 to about 3.

In some aspects, an alkalizing agent is added to the composition in order to obtain the desirable neat pH of the composition. However, even when the composition comprises an alkalizing agent, an acidic pH must be maintained in the final product.

Unless otherwise stated herein, the pH of the composition is defined as the neat pH of the composition at 20±2° C. Any meter capable of measuring pH to ±0.01 pH units is suitable. Orion meters (Thermo Scientific, Clintinpark-Keppekouter, Ninovesteenweg 198, 9320 Erembodegem-Aalst, Belgium) or equivalent are acceptable instruments. The pH meter should be equipped with a suitable glass electrode with calomel or silver/silver chloride reference. An example includes Mettler DB 115. The electrode should be stored in the manufacturer's recommended electrolyte solution. The pH is measured according to the standard procedure of the pH meter manufacturer. Furthermore, the manufacturer's instructions to set up and calibrate the pH assembly should be followed.

In some aspects, the stain removing compositions of the present invention have a reserve acidity to pH 7.00 of at least about 1, or at least about 3, or at least about 5. In some aspects, the compositions herein have a reserve acidity to pH 7.00 of from about 3 to about 10, or from about 4 to about 7. As used herein, “reserve acidity” refers to the grams of NaOH per 100 g of product required to attain a pH of 7.00. The reserve acidity measurement as used herein is based upon titration (at standard temperature and pressure) of a 1% product solution in distilled water to an end point of pH 7.00, using standardized NaOH solution. Without being limited by theory, the reserve acidity measurement is found to be the best measure of the acidifying power of a composition, or the ability of a composition to provide a target acidic wash pH when added at high dilution into tap water as opposed to pure or distilled water. The reserve acidity is controlled by the level of formulated organic acid along with the neat product pH as well as, in some aspects, other buffers, such as alkalizing agents, for example, alkanolamines.

The stain removing compositions herein may be in the form of gels or liquids. In some aspects, the compositions have a viscosity less than about 200 cps measured at 20 s⁻¹ at 21.1° C. In some aspects, the compositions have viscosities of from about 30 cps to about 500 cps, or from about 50 cps to about 150 cps, or from about 50 cps to about 100 cps.

As used herein, unless specifically indicated to the contrary, all stated viscosities are those measured at a shear rate of 20 s⁻¹ at a temperature of 21.1° C. Viscosity herein can be measured with any suitable viscosity-measuring instrument, e.g., a Carrimed CSL2 Rheometer.

The compositions of the present invention may comprise one or more laundry adjuncts, such as builders, enzymes, stabilizers, perfumes, suds-supressors, soil-suspension polymers, soil release polymers, dye-transfer inhibitors, halide salt, and/or other benefit agents. In some aspects, the compositions comprise from about 0.01% to about 50% of a laundry adjunct. In addition to the disclosure below, further description of suitable adjuncts can be found in US Patent Application 20130072415A1, incorporated herein by reference.

The stain removing compositions may comprise a builder. Suitable builders herein can be selected from the group consisting of aluminosilicates and silicates; carbonates, bicarbonates, sesquicarbonates and carbonate minerals other than sodium carbonate or sesquicarbonate; organic mono-, di-, tri-, and tetracarboxylates especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing stain removing compositions.

In some aspects, the composition comprises from about 0.00001% to about 0.01% active enzymes that are stable and effective in a low-pH environment. Suitable enzymes may include proteases, lipases, and carbohydrases, including amylases and cellulases.

The compositions may comprise perfume, such as, for example, the compositions may comprise between 0.1% by weight to 5% by weight of perfume, such as, for example, .5%, 1%, 1.5%, 2%, 2.5%, 3% by weight of perfume. The perfume may be an acid-stable perfume. The perfume may be derived or may comprise an essential oil. Essential oils include and are not limited to Thyme, lemongrass, citrus, lemon, orange, anise, clove, aniseed, cinnamon, geranium, roses, mint, lavender, citronella, eucalyptus, peppermint, camphor, sandalwood and cedar. Actives of essential oils include and are not limited to thymol, eugenol, menthol, geraniol, verbenone, eucalyptol and pinocarvone, cedrol, anethol, carvacrol, hinokitiol, berberine, terpineol, limonene.

In some aspects, the compositions disclosed herein may comprise a perfume delivery system. Suitable perfume delivery systems, methods of making certain perfume delivery systems, and the uses of such perfume delivery systems are disclosed in USPA 2007/0275866 A1. Such perfume delivery system may be a perfume microcapsule. The perfume microcapsule may comprise a core that comprises perfume and a shell, with the shell encapsulating the core. The shell may comprise a material selected from the group consisting of aminoplast copolymer, an acrylic, an acrylate, and mixtures thereof. The aminoplast copolymer may be melamine-formaldehyde, urea-formaldehyde, cross-linked melamine formaldehyde, or mixtures thereof. The perfume microcapsule's shell may be coated with one or more materials, such as a polymer, that aids in the deposition and/or retention of the perfume microcapsule on the site that is treated with the composition disclosed herein. The polymer may be a cationic polymer selected from the group consisting of polysaccharides, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide, and mixtures thereof. The perfume microcapsule may be friable and/or have a mean particle size of from about 10 microns to about 500 microns or from about 20 microns to about 200 microns. In some aspects, the composition comprises, based on total composition weight, from about 0.01% to about 80%, or from about 0.1% to about 50%, or from about 1.0% to about 25%, or from about 1.0% to about 10% of perfume microcapsules. Suitable capsules may be obtained from Appleton Papers Inc., of Appleton, Wis. USA. Formaldehyde scavengers may also be used in or with such perfume microcapsules.

In some aspects, the compositions are essentially free of suds suppressor. In some aspects, the compositions comprise less than or equal to about 0.02% suds suppressor. Examples of suds suppressors useful herein include silica/silicone type, silicone oil, branched alcohols, or mixtures thereof In some aspects, the composition comprises from about 0.05% about 1%, or from about 0.1% to about 0.4% suds supressors.

The compositions of the present disclosure may contain a soil suspension polymer; as described above, some polyamine soil suspension polymers may contribute to chemical stability of the composition or suds benefits in addition to offering cleaning benefits. In some aspects, the soil suspension polymer is selected from PEI ethoxylates, HMDA diquaternized ethoxylates, sulfonated derivatives thereof, hydrophobically modified anionic copolymers, amphiphilic graft polymers, or mixtures thereof. Examples of hydrophobically modified anionic copolymers useful herein include Acusol 480 ®, commercially available from Rohm and Haas and Alcosperse® 725 and 747 and Alcogum L520, commercially available from Alco Chemical. Suitable polymers are described in, for example, U.S. Pat. No. 7,951,768, incorporated herein by reference.

The compositions of the present disclosure may contain a soil release polymer. In one aspect, the soil release polymer is a PET alkoxylate short block copolymer, anionic derivatives thereof, or mixtures thereof.

The compositions of the present disclosure may contain dye transfer inhibitors and/or dye fixatives. Examples of dye transfer inhibitors useful herein include polyvinylpyrrolidone, poly-4-vinylpyridine-N-oxide, copolymers of N-vinyl-2-pyrrolidone and N-vinylimidazole, or mixtures thereof. Useful dye fixatives are disclosed in U.S. Pat. No. 6,753,307.

### Inorganic Salt

The composition may comprise inorganic salt. It has been found that inorganic salt may provide stability benefit to sulfated surfactant compositions. Certain inorganic salts may also help to build viscosity. The inorganic salt may comprise an alkali metal, an alkali earth metal, ammonium, or mixtures thereof. In some aspects, the inorganic salt comprises sodium, potassium, magnesium, calcium, ammonium, or mixtures thereof. The inorganic salt may comprise a halide, a sulfate, a carbonate, a bicarbonate, a phosphate, a nitrate, or mixtures thereof. In some aspects, the inorganic salt is sodium chloride, magnesium chloride, calcium chloride, sodium sulfate, magnesium sulfate, calcium sulfate, or mixtures thereof; in some aspects, the inorganic salt is sodium chloride, sodium sulfate, or mixtures thereof. The composition may comprise from about 0.1%, or from about 0.5%, to about 5%, or to about 3%, or to about 2%, or to about 1%, by weight of the composition, of inorganic salt.

TABLE 1
Formulation Range and Examples

| Material | Formula Range | Example 1 | Example 2 |
|---|---|---|---|
| Alkalizing Agent | 0-3% | 1.6% | 0.5% |
| Organic acid | 10-25% | 20% | 14% |
| Chelant | 0-5% | 0.5% | 0.2% |
| Colorants | 0-1% | 0.01% | 0.1% |
| FWA (brightener) | 0-5% | 0.2% | 0.15% |
| Perfume | 0-5% | 0.5% | 0.68% |
| Polymer | 0-10% | 3% | 2% |
| Solvent | 0-15% | 0.6% | 10% |
| Surfactant | 0.01%-50% | 28% | 18% |
| Water | 0-80% | Balance | Balance |

### Comparative Stain Removal

TABLE 2
Comparative Product Compositions

| Composition | Ingredients |
|---|---|
| Henkel | Water, soluble builder block comprised |
| (DE102014225185) | of citric acid, alkali metal silicate, phosphonic |
| | acid, alkali phosphate, polymeric |
| | polycarboxylate, amine oxide, and detergent. |
| Deo-Go Underarm | Muriatic acid (Hydrochloric acid), nonionic |
| Stain Remover | surfactants, perfume, and other ingredients. |

100% cotton consumer fabrics in the form of t-shirts (fabric samples) containing visible underarm stains were tested. The fabric samples can be washed in a Whirlpool® front loader washing machine, using 7 grains per gallon water hardness and washed at 77 degrees Fahrenheit. The total amount of stain remover applied to the underarm stains in the test was 60 grams.

Standard colorimetric measurement is used to obtain L*, a* and b* values for each stain before and after the washing. From L*, a* and b* values, the stain level is calculated.

Stain removal from the swatches was measured as follows:

$$Stain Removal Index ( SRI ) = \frac{Δ {E}_{initial} - Δ {E}_{washed}}{Δ {E}_{initial}} \times 100$$

$$Δ {E}_{initial} = Stain level before washing$$

$$Δ {E}_{washed} = Stain level after washing$$

The SRI values shown below are the averaged SRI. The stain level of the fabric before the washing (ΔEᵢₙᵢₜᵢₐₗ) is high; in the washing process, stains are removed and the stain level after washing is reduced (ΔE_{washed}). The better a stain has been removed, the lesser the value for ΔE_{washed} and the greater the difference between ΔEᵢₙᵢₜᵢₐₗ and ΔE_{washed} (ΔEᵢₙᵢₜᵢₐₗ−ΔE_{washed}). Therefore the value of the stain removal index increases with better washing performance.

TABLE 3
SRI data for Underarm stains at soaking time intervals

| Time | Example 1 | Example 2 | Henkel | Deo-Go |
|---|---|---|---|---|
| 1 Hour | 52 | 32 | 25 | 29 |

As shown above, the formulations of Example 1 and Example 2 exhibit significantly higher SRI scores at the one hour mark when compared to in-market formulations (Deo-Go) and other competitive formulations (Henkel). Additionally, as shown above, one can create a formulation, without phosphates or hydrochloric acid, that works significantly better, even at the one hour mark, compared to formulations that utilize Hydrochloric acid and phosphonic acid. For example, when compared to the Henkel formulation, the formulation of Example 1 has an almost double SRI. Additionally, compared to Deo-Go, Example 1 similarly came out with an at least 40% greater SRI.

Without being bound by theory, it is believed that the compositions of Examples 1 and 2 exhibit higher or equivalent SRI scores when compared to competitive formulations at not only the one hour soak duration but also at 2 hours, 4 hours, 8 hours, 12 hours, and 24 hours.

Additionally, without being bound by theory, it is believed that the compositions of Examples 1 and 2 enable one to treat the fabric and wash it at a time of their choosing, such as, for example, 24 hours later. Said otherwise, one may treat the fabric and wash it after 1 hour, 2 hours, 4 hours, 8 hours, 12 hours, 24 hours or 48 hours without the stain removal composition having an adverse effect to the fabric being treated such as, for example, fiber and/or color degradation. Because the average consumer does at least 3 loads of laundry per week, the compositions of Examples 1 and 2 allows the user to treat the fabric at the time of removal after use and place it aside in a hamper or pile of used clothing until they choose to do laundry without having to worry about the treatment causing adverse effects on the fabric.

Without being bound by theory, it is believed that by utilizing a formula that is phosphate free, one can formulate a stain removal composition that can be left on the stained fabric for an extended period of time, at least greater than one hour, without having an adverse effect on the fabric or the colors of the fabric. Said otherwise, it is believed that the formulations of Examples 1 and 2 do not irreversibly interact with one or more dyes within the fabric.

The benefit described above for the disclosed formulation of Examples 1 and 2 can be exemplified by testing the effect of different compositions on various fabric dyes such as, for example, blue copper, acid violet, reactive black 5, and/or indigo dye. The effect can be measured using a spectrophotomer and quantified using a Delta E of the LAB measurements.

As used herein and as will be familiar one of ordinary skill, the “L*C*h color space” and “L*a*b* color space” are three dimensional colorimetric models developed by Hunter Associates Laboratory and recommended by the Commission Internationale d′Eclairage (“CIE”) to measure the color or change in color of a dyed article. The CIE L*a*b* color space (“CIELAB”) has a scale with three-fold axes with the L axis representing the lightness of the color space (L*=0 for black, L*=100 for white), the a* axis representing color space from red to green (a*>0 for red, a*<0 for green) and the b* axis representing color space from yellow to blue (b*>0 for yellow, b*<0 for blue). The L*C*h color space is an approximately uniform scale with a polar color space. The CIE L*C*h color space (“CIELCh”) scale values are determined instrumentally and may also be calculated from the CIELAB scale values. Term definitions and equation derivations are available from Hunter Associates Laboratory, Inc. and from www.hunterlab.com, and are incorporated in their entirety by reference herein.

The amount of dye fading onto fabrics can be described, for example, in terms of the change in L*C*h before and after treatment of the fabric as measured via spectrophotometry (for example, via a Spectrophotomer CM-3610d, manufactured by Konica Minolta, Tokyo, Japan and is reported as dE value. As used herein, the dE value includes the vector associated with the distance in the L*C*h space between the initial L*C*h value and the final L*C*h value. An average of L*a*b* measures are taken per test fabric, and one or more fabrics are measured per example. Relatively higher dE values correspond to a greater color change, indicating more dye fading on fabric.

These results illustrate the surprising stain removal benefits of the composition(s) disclosed herein, as compared to prior taught formulations, both in-market and not in-market.

### Method of Use:

As previously disclosed, the stain treatment composition may be used by placing the composition in contact with the desired stain on the fabric, allowing the composition to stay on the stain for a period of time, and at a future time, washing the fabric containing the stain. The composition may be placed in contact by spraying the composition, scrubbing the composition, pouring the composition, dipping the stain into a container comprising the composition, and/or a combination of the options presented. Once the stain is placed in contact with composition, the composition may remain on the stain for a period of 1 hour or greater such as, for example, between 1 hour and 48 hours, between 1.5 hours and 48 hours, between 2 hours and 36 hours, such as, for example, 2 hours, 4 hours, 8 hours, 12 hours, 24 hours, 48 hours or any interval therebetween the 1 hour and 48 hours. The composition may interact with one or more aluminum compounds in the stained areas of the fabric while remaining on the stain. Simultaneously while interacting with the one or more aluminum compounds, the composition does not irreversibly interact with one or more dyes within the fabric. The fabric may be washed or laundered in cold, warm, or hot water with a laundry detergent.

### Packaging for the Compositions

The stain removing compositions described herein can be packaged in any suitable container including those constructed from paper, cardboard, plastic materials, and any suitable laminates.

The stain removing compositions described herein may also be packaged as a multi-compartment stain removing composition.

The present disclosure also relates to a transparent or translucent liquid laundry stain removing composition in a transparent bottle, where the composition comprises from about 1% to about 20% by weight of alkyl ether sulfate of the formula R¹—(OCH₂CH₂)ₓ—O—SO₃M, where R¹ is a non-petroleum derived, linear or branched fatty alcohol consisting of even numbered carbon chain lengths of from about C₈ to about C₂₀, and where x is from about 0.5 to about 8, and where M is an alkali metal or ammonium cation; from about 1% to about 15% by weight of fatty alcohol ethoxylate of formula R²—(OCH₂₂CH₂)_{y}—OH, where R² is a non-petroleum derived, linear or branched fatty alcohol consisting of even numbered carbon chain lengths of from about C10 to about C18, and where y is from about 0.5 to about 15; from about 0.1% to about 5% by weight of amine oxide; from about 0.1% to about 5% of a cleaning polymer; from about 1% to about 15% by weight of a solvent comprising 1,2-propanediol; and water; where the transparent or translucent composition has about 50% transmittance or greater of light using 1 cm cuvette at wavelength of 410-800 nanometers; and where the transparent bottle has light transmittance of greater than 25% at wavelength of about 410-800 nm.

Clear bottle materials that may be used include, but are not limited to: polypropylene (PP), polyethylene (PE), polycarbonate (PC), polyamides (PA) and/or polyethylene terephthalate (PETE), polyvinylchloride (PVC); and polystyrene (PS).

The transparent bottle or container may have a transmittance of more than about 25%, or more than about 30%, or more than about 40%, or more than about 50% in the visible part of the spectrum (approx. 410-800 nm). Alternatively, absorbency of the bottle may be measured as less than about 0.6 or by having transmittance greater than about 25%, where % transmittance equals:

$$\frac{1}{{10}^{absorbancy}} \times 100 \%$$

For purposes of the disclosure, as long as one wavelength in the visible light range has greater than about 25% transmittance, it is considered to be transparent/translucent.

The container or bottle may be of any form or size suitable for storing and packaging liquids for household use. For example, the container may have any size but usually the container will have a maximal capacity of about 0.05 to about 15 L, or about 0.1 to about 5 L, or from about 0.2 to about 2.5 L. The container may be suitable for easy handling. For example, the container may have handle or a part with such dimensions to allow easy lifting or carrying the container with one hand. The container may have a means suitable for pouring a liquid stain removing composition and means for reclosing the container. The pouring means may be of any size or form. The closing means may be of any form or size (e.g., to be screwed or clicked on the container to close the container). The closing means may be cap, which can be detached from the container. Alternatively, the cap may be attached to the container, whether the container is open or closed. The closing means may also be incorporated in the container.

The compositions of the present disclosure can be formulated according to conventional methods such as those described as in U.S. Pat. No. 4,990,280; U.S. 20030087791A1; U.S. 20030087790A1; U.S. 20050003983A1; U.S. 20040048764A1; U.S. Pat. Nos. 4,762,636; 6,291,412; U.S. 20050227891A1; EP 1070115A2; U.S. Pat. Nos. 5,879,584; 5,691,297; 5,574,005; 5,569,645; 5,565,422; 5,516,448; 5,489,392; and 5,486,303, all of which are incorporated herein by reference.

The stain removing compositions of the present disclosure may be used to clean, treat, and/or pretreat a fabric. In some aspects, the present disclosure provides a method of treating a surface, comprising the step of contacting the surface with the stain removing compositions of the present invention. Typically at least a portion of the fabric is contacted with the aforementioned stain removing compositions, in neat form or diluted in a liquor, e.g., a wash liquor, and then the fabric may be optionally washed and/or rinsed. In one aspect, a fabric is optionally washed and/or rinsed, contacted with the aforementioned stain removing compositions and then optionally washed and/or rinsed. In another aspect, the stain removing composition is applied onto the soiled fabric and left to act on the fabric before the fabric is washed. The composition may remain in contact with the fabric until dry or for a longer period of time, or for a period of about 1 minute to about 24 hours, or about 1 minute to about 1 hour, or about 5 minutes to about 30 minutes. As previously disclosed, the composition may be applied to the fabric up to 48 hours prior to laundering the fabric. For purposes of the present disclosure, washing includes, but is not limited to, scrubbing, brushing, and mechanical agitation. Typically after washing and/or rinsing, the fabric is dried. The fabric may comprise most any fabric capable of being laundered or treated. The washing may take place, for example, in a conventional fabric laundering automatic washing machine or by a hand washing method. An effective amount of the stain removing composition may be added to water to form aqueous laundering solutions that may comprise from about 200 to about 15,000 ppm or even from about 300 to about 7,000 pm of stain removing composition.

### Combinations:

A. A composition for removing stains by the interaction of perspiration with aluminum compounds from fabrics comprising:
between 10% and 25% of an organic acid;
a surfactant;
a polymer;
and water.
B. The composition of paragraph A, wherein said composition further comprises a dye.
C. The composition of any of paragraphs A-B, wherein the composition is phosphate free and free of any phosphoric acid.
D. The composition of any of paragraphs A-C, wherein the composition comprises a chelant.
E. The composition of in paragraph D, wherein the composition comprises up to 5% of the chelant.
F. The composition of any of paragraphs A-E, wherein the surfactant is present in an amount of between 0.01% and 50% by weight of the composition.
G. The composition of any of paragraphs A-F, wherein the organic acid is selected from the group consisting of from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-di succinic acid, tartaric-monosuccinic acid, or mixtures thereof.
H. A method of treating a stain caused by the interaction of perspiration with aluminum compounds, said method comprising the steps of:
providing the composition of any of claims A-G;
applying the composition directly on the one or more stains on the fabric;
allowing the composition to interact with one or more aluminum compounds in the stained areas of the fabric for at least 5 minutes; and
laundering the fabric in water mixed with a laundry detergent.
I. The method of paragraph H, wherein the method further comprises allowing the composition to interact with one or more aluminum compounds in the stained areas of the fabric for greater than 1 hour.
J. The method of any of paragraphs H-I, wherein the method further comprises allowing the composition to interact with one or more aluminum compounds in the stained areas of the fabric for between 1.5 and 48 hours.
K. The method of paragraph J, wherein the composition does not irreversibly interact with one or more dyes within the fabric.
L. The method of paragraph K, wherein the one or more dyes consist of reactive black 5, blue copper dyes, acid violet 4, sulfur dyes, and indigo dyes, and combinations thereof.

M. The method of any of paragraphs H-L, wherein the phosphate free and free of any phosphoric acid composition further comprises a chelant.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A composition for removing stains by the interaction of perspiration with aluminum compounds from fabrics comprising:
between 10% and 25% of an organic acid;
a surfactant;
a polymer;
and water.

2. The composition as recited in claim 1 wherein said composition further comprises a dye.

3. The composition of claim 1, wherein the composition is phosphate free and free of any phosphoric acid.

4. The composition of claim 1, wherein the composition comprises a chelant.

5. The composition of claim 4, wherein the composition comprises up to 5% of the chelant.

6. The composition of claim 1, wherein the surfactant is present in an amount of between 0.01% and 50% by weight of the composition.

7. The composition of claim 1, wherein the organic acid is selected from the group consisting of from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof

8. A composition for removing stains by the interaction of perspiration with aluminum compounds from fabrics comprising:
between 10% and 25% of an organic acid selected from the group consisting of from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof;
a surfactant;
a polymer;
an alkalizing agent;
and water.

9. The composition of claim 8, wherein the composition is phosphate free and free of any phosphoric acid.

10. The composition of claim 8, wherein the composition comprises a chelant.

11. The composition of claim 10, wherein the composition comprises up to 5% of the chelant.

12. The composition of claim 8, wherein the surfactant is present in an amount of between 0.01% and 50% by weight of the composition.

13. The composition of claim 8, wherein the composition comprises a brightener.

14. The composition of claim 8, wherein the composition comprises a dye.

15. A method of treating a stain caused by the interaction of perspiration with aluminum compounds, said method comprising the steps of:
providing a phosphate free and free of phosphoric acid composition comprising:
between 10% and 25% of an organic acid,
a surfactant,
a polymer,
an alkalizing agent,
and water;
applying the composition directly on the one or more stains on the fabric;
allowing the composition to interact with one or more aluminum compounds in the stained areas of the fabric for at least 5 minutes; and
laundering the fabric in water mixed with a laundry detergent.

16. The method of claim 15, wherein the method further comprises allowing the composition to interact with one or more aluminum compounds in the stained areas of the fabric for greater than 1 hour.

17. The method of claim 15, wherein the method further comprises allowing the composition to interact with one or more aluminum compounds in the stained areas of the fabric for between 1.5 and 48 hours.

18. The method of claim 17, wherein the composition does not irreversibly interact with one or more dyes within the fabric.

19. The method of claim 18, wherein the one or more dyes consist of reactive black 5, blue copper dyes, acid violet 4, sulfur dyes, and indigo dyes, and combinations thereof

20. The method of claim 15, wherein the phosphate free and free of any phosphoric acid composition further comprises a chelant.
